(19) United States
(12) Patent Application Publication
(10) Pub. No.: US 2017/0080738 A1
(43) Pub. Date: Mar. 23, 2017

(54) PRINTING SCREEN UNITS AND METHOD OF FABRICATING THE SAME

(71) Applicant: ASM Assembly Systems Weymouth Limited, Weymouth (GB)

(72) Inventors: Lee Edward James BAILEY, Dorset (GB); Robin Alec MANN, Dorset (GB); Scott HAMMOND, Dorset (GB)

(21) Appl. No.: 15/312,449

(22) PCT Filed: May 19, 2015
(86) PCT No.: PCT/EP2015/061032

§ 371 Date: Nov. 18, 2016

(30) Foreign Application Priority Data
May 19, 2014 (GB) 1408886.8

(51) Int. Cl. B41N 1/24; B41C 1/14; B41F 15/36; B41M 1/12

(52) U.S. Cl. CPC B41N 1/247; B41M 1/12; B41C 1/141; B41F 15/36; B41N 1/248; B41N 1/241; B41P 2200/40; B41P 2215/12

(57) ABSTRACT

A printing screen unit comprising a mesh printing screen and a supporting frame which is attached to the printing screen, wherein the printing screen comprises a first, outer mesh which is attached to sides of the supporting frame and includes an aperture therein, and a second, inner mesh which is attached to the outer mesh, wherein threads, providing warp and weft, of the outer mesh are aligned so as to be substantially orthogonal to the sides of the supporting frame, wherein threads, providing warp and weft, of the inner mesh being aligned so as to have acute angles of between 0 degrees and 45 degrees to the respective sides of the supporting frame, wherein the printing screen is tensioned by an external tensioning assembly to a first tension when the printing screen is attached to the supporting frame, and the sides of the supporting frame are displaceable such that the sides of the supporting frame are displaced on release of the first tension by the external tensioning assembly, and the printing screen has a second, residual tension lower than the first tension.

The present invention relates to printing screen units which incorporate mesh printing screens, often alternatively referred to as stencils or masks, for use in the screen printing of workpieces, typically electronic substrates, such as wafers, circuit boards and components, and methods of fabricating the same.

Traditionally, mesh printing screens comprising a flexible, perforate sheet, such as of a woven mesh of polypropylene or stainless steel strands, have been attached under tension directly to large rectangular frames.

Whilst the above-described mounting system has been well used, the mounting system does exhibit a number of drawbacks, notably in not allowing the printing screen to be detached from the frame, and thus requires a large storage facility for storing a large number of mounted printing screens.

Various de-mountable solutions have been proposed for metal sheet type printing screens, such as WO-A-2003/093012, but mesh type screens present a particular challenge, in requiring that the mesh screens be maintained under a relatively-high tension, which necessitates a substantial supporting frame.

The present inventors have recognized that it is possible to adapt the frame assembly of WO-A-2003/093012 to accommodate mesh screens, thereby obviating the need for the mesh screens to be stored on large frames.

In one aspect the present invention provides a printing screen unit comprising a mesh printing screen and a supporting frame which is attached to the printing screen, wherein the printing screen comprises a first, outer mesh which is attached to sides of the supporting frame and includes an aperture therein, and a second, inner mesh which is attached to the outer mesh, wherein threads, providing warp and weft, of the outer mesh are aligned so as to be substantially orthogonal to the sides of the supporting frame, wherein threads, providing warp and weft, of the inner mesh being aligned so as to have acute angles of between 0 degrees and 45 degrees to the respective sides of the supporting frame, wherein the printing screen is tensioned by an external tensioning assembly to a first tension when the printing screen is attached to the supporting frame, and the sides of the supporting frame are displaceable such that the sides of the supporting frame are displaced on release of the first tension by the external tensioning assembly, and the printing screen has a second, residual tension lower than the first tension.

In another aspect the present invention provides a method of fabricating a printing screen unit, comprising: forming an aperture in a first mesh, wherein threads, providing warp and weft, of the first mesh are aligned so as to be in first and second orthogonal directions; locating a second mesh over the aperture in the first mesh, wherein threads, providing warp and weft, of the second mesh are aligned so as to have acute angles of between 0 degrees and 45 degrees to the respective ones of the first and second orthogonal directions of the first mesh; attaching the second mesh to the first mesh so as to provide a mesh printing screen; tensioning the printing screen by applying a first tension to the printing screen using an external tensioning assembly; disposing a supporting frame to the printing screen, wherein sides of the supporting frame are displaceable; attaching the printing screen to the sides of the supporting frame while maintaining the printing screen at the first tension; following attachment of the printing screen to the supporting frame, removing the first tension applied to the printing screen; whereby the sides of the supporting frame are displaced by the first tension in the printing screen, whereby the printing screen has a second, residual tension lower than the first tension.

In a further aspect the present invention provides a method of screen printing patterns of deposits on workpieces, comprising: using a printing screen unit comprising a mesh printing screen and a supporting frame which is attached to the printing screen, wherein the printing screen comprises a first, outer mesh which is attached to sides of the supporting frame and includes an aperture therein, and a second, inner mesh which is attached to the outer mesh, wherein threads, providing warp and weft, of the outer mesh are aligned so as to be substantially orthogonal to the sides of the supporting frame, wherein threads, providing warp and weft, of the inner mesh being aligned so as to have acute angles of between 0 degrees and 45 degrees to the respective sides of the supporting frame, wherein the printing screen has a residual tension which is provided by tensioning the printing screen by an external tensioning assembly to a first tension when the printing screen is attached to the supporting frame, and releasing the first tension following attachment of the printing screen to the supporting frame, such that sides of the supporting frame are displaced by the first tension to leave the printing screen with the residual tension which is lower than the first tension; tensioning the printing screen unit in a frame assembly to a second tension higher than the residual tension; and printing patterns of deposits on workpieces using the printing screen unit tensioned in the frame assembly.

In a still further aspect the present invention provides a mesh printing screen, comprising a mesh layer, a first layer of emulsion which is applied to the mesh layer, the first layer including a pattern of printing apertures through which a printing medium is deposited on a workpiece in a printing operation, and a second, stand-off layer which is beneath the emulsion layer and includes a plurality of apertures in registration with the printing apertures in the first layer and acts to provide a stand-off when printing on a workpiece which includes upstanding features.

In a yet further aspect the present invention provides a method of fabricating a printing screen unit, comprising: providing a printing screen comprising a mesh, wherein threads, providing warp and weft, of the mesh are aligned so as to be in first and second orthogonal directions; disposing the printing screen over a supporting frame, wherein the supporting frame comprises first and second pairs of interface members which provide sides of the supporting frame and the interface members are configured so as to be resiliently deflectable on application of tension thereto by external tensioning mechanisms, and the threads of the mesh are aligned so as to have acute angles of between 0 degrees and 30 degrees to the respective sides of the supporting frame; attaching the printing screen to the sides of the supporting frame while maintaining the printing screen at a first tension; and following attachment of the printing screen to the supporting frame, removing the first tension applied to the printing screen, whereby the printing screen has a second, residual tension lower than the first tension.

In a still yet further aspect the present invention provides a method of fabricating a printing screen unit, comprising: providing a printing screen comprising a mesh, wherein threads, providing warp and weft, of the mesh are aligned so as to be in first and second orthogonal directions; disposing the printing screen over a supporting frame, wherein the supporting frame comprises first and second pairs of interface members which provide sides of the supporting frame and the interface members are configured so as to be resiliently deflectable on application of tension thereto by external tensioning mechanisms, and the threads of the mesh are aligned so as to have acute angles of between 0 degrees and 30 degrees to the respective sides of the supporting frame; attaching the printing screen to the sides of the supporting frame while maintaining the printing screen at a first tension; and following attachment of the printing screen to the supporting frame, removing the first tension applied to the printing screen, whereby the printing screen has a second, residual tension lower than the first tension.

Preferred embodiments of the present invention will now be described hereinbelow by way of example only with reference to the accompanying drawings, in which:

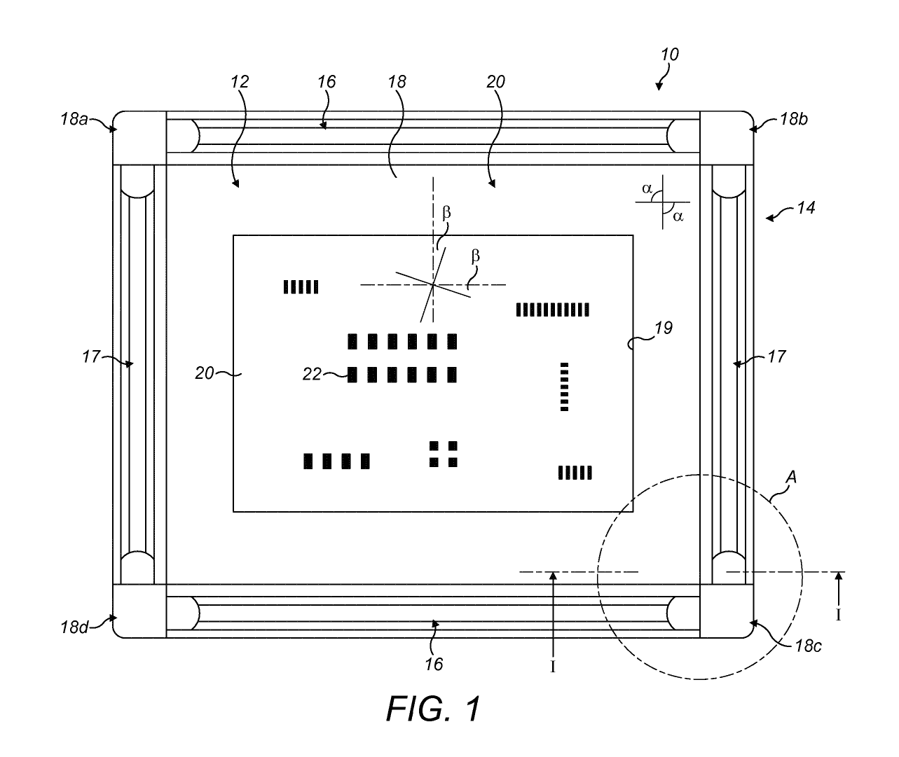

FIG. 1 illustrates a plan view of a printing screen unit in accordance with a first embodiment of the present invention;

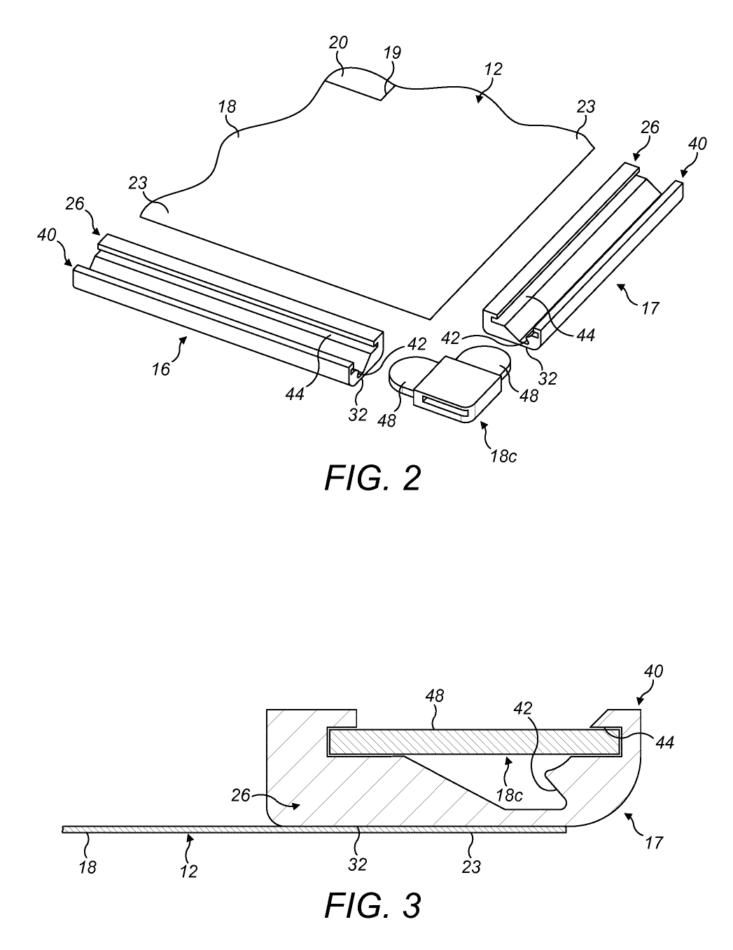

FIG. 2 illustrates an exploded perspective view from above of one corner region (region A in FIG. 1) of the printing screen unit of FIG. 1;

FIG. 3 illustrates a vertical sectional view (along section I-I in FIG. 1) through an edge region of the printing screen unit of FIG. 1;

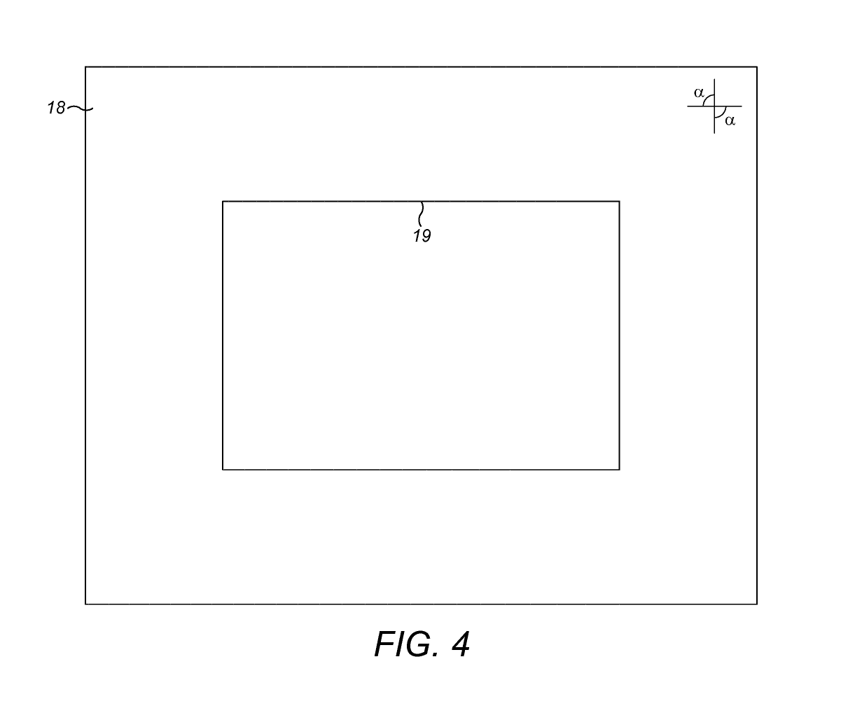

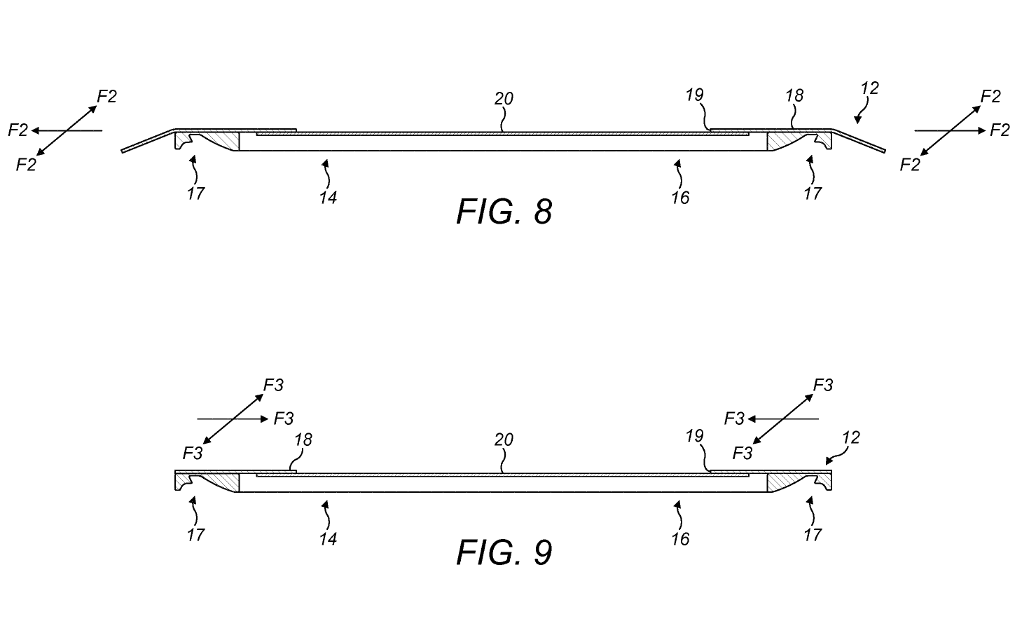

FIGS. 4 to 9 illustrate the operative steps in fabricating the printing screen unit of FIG. 1;

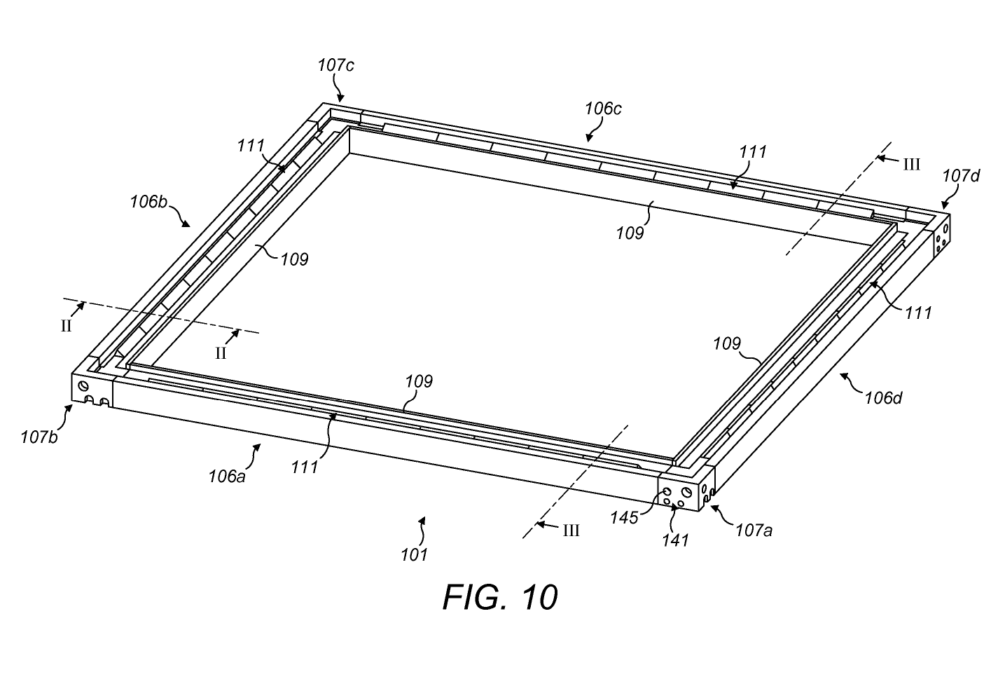

FIG. 10 illustrates a perspective view of a frame assembly for use in tensioning the printing screen unit of FIG. 1;

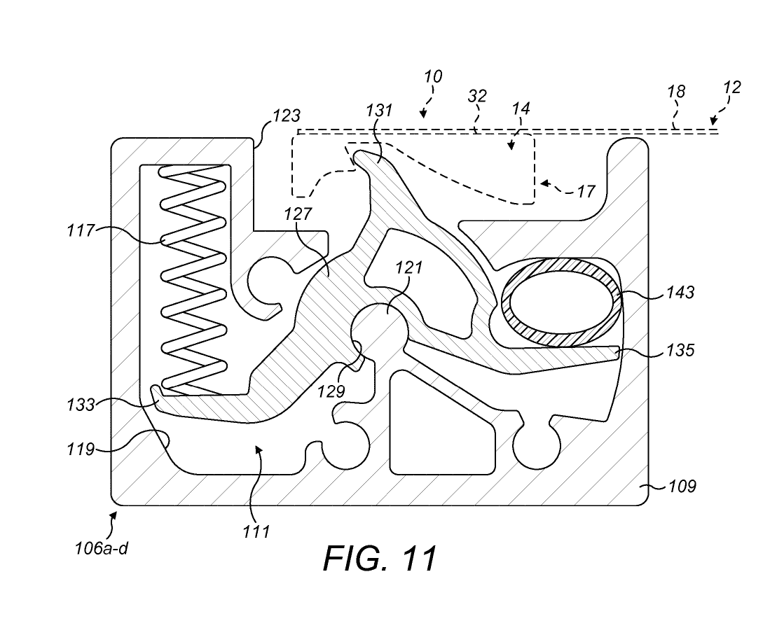

FIG. 11 illustrates a vertical sectional view (along section II-II in FIG. 10) through one of the frame members of the frame assembly of FIG. 10;

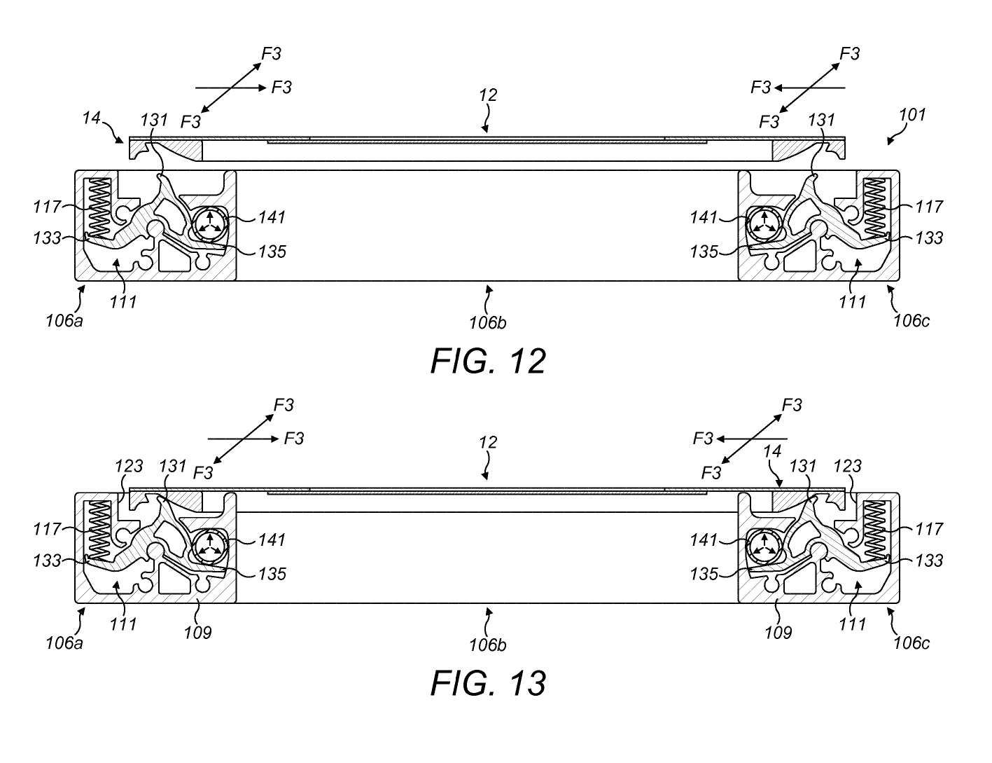

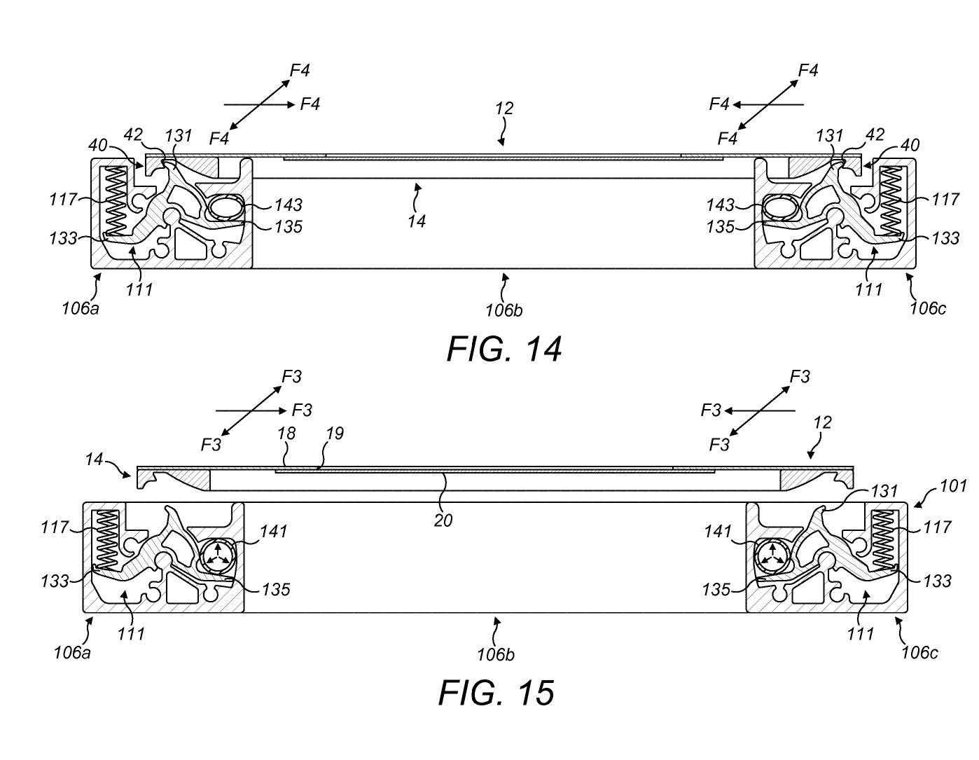

FIGS. 12 to 15 illustrate the operative steps in tensioning the printing screen unit of FIG. 1 using the frame assembly of FIG. 10 (along section III-III in FIG. 10);

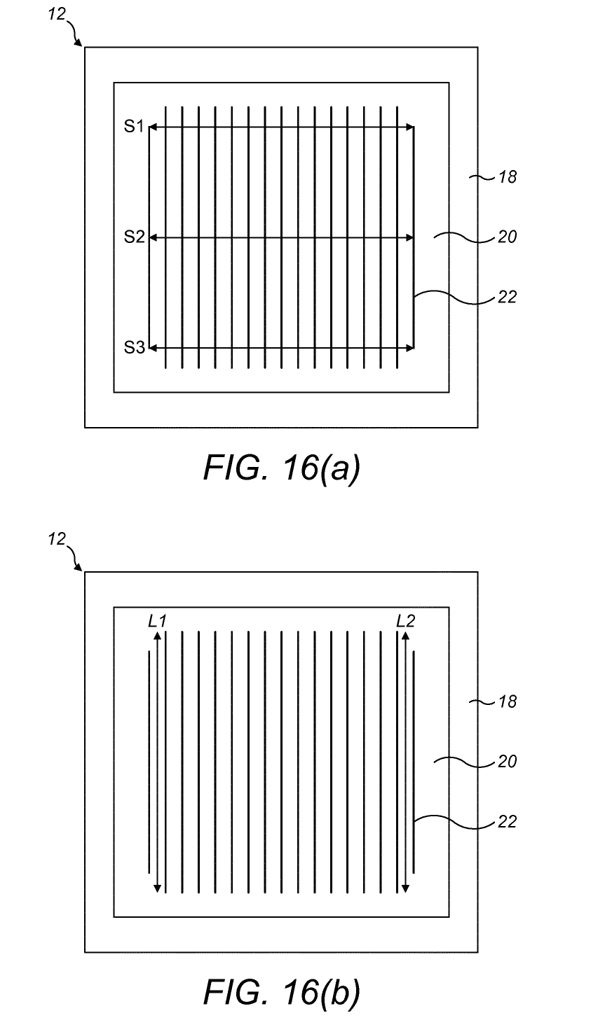

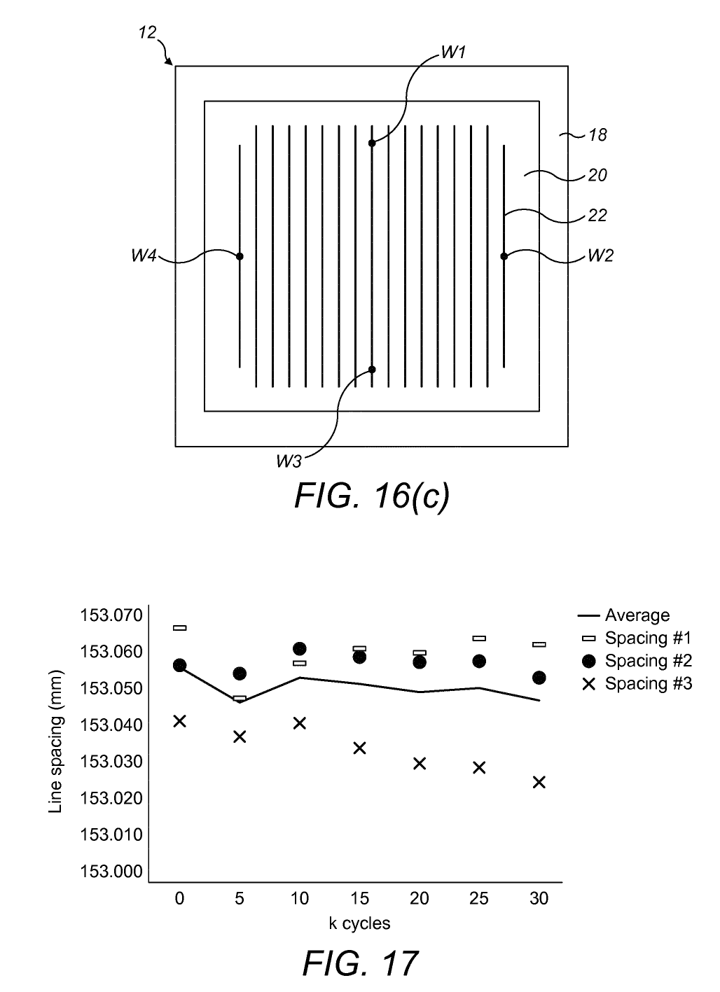

FIGS. 16(a) to (c) represent the spacings S1, S2 and S3, the lengths L1 and L2 and the widths W1, W2, W3 and W4 of the printing screen unit of FIG. 1 as measured in Example #1;

FIG. 17 illustrates measured spacings S1, S2 and S3 as a function of the number of print cycles in accordance with Example #1;

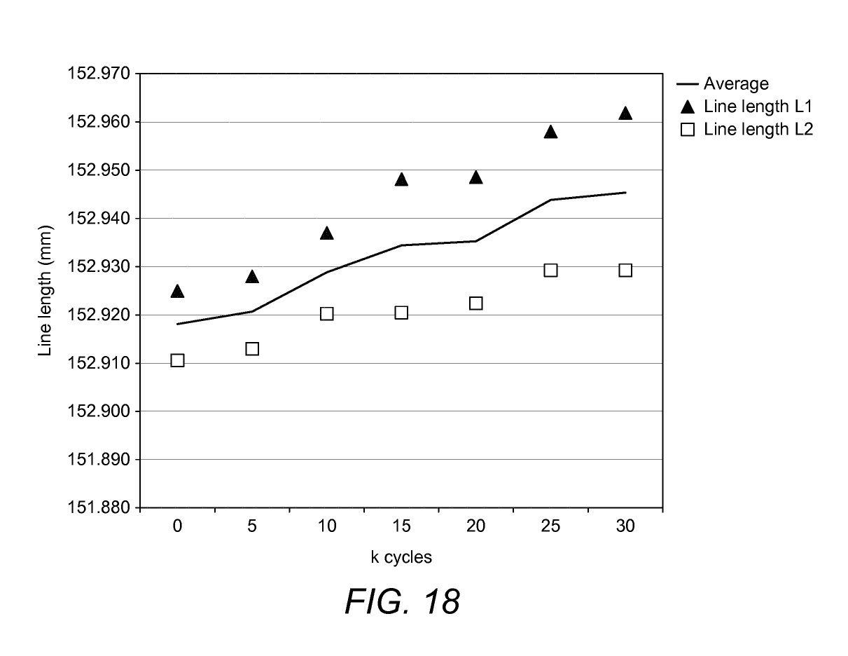

FIG. 18 illustrates measured lengths L1 and L2 as a function of the number of print cycles in accordance with Example #1;

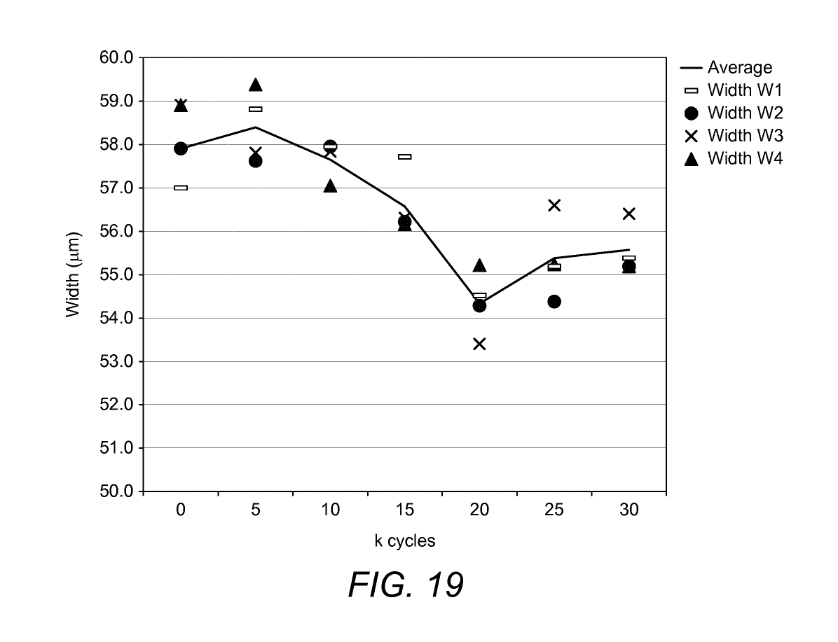

FIG. 19 illustrates measured widths W1, W2, W3 and W4 as a function of the number of print cycles in accordance with Example #1;

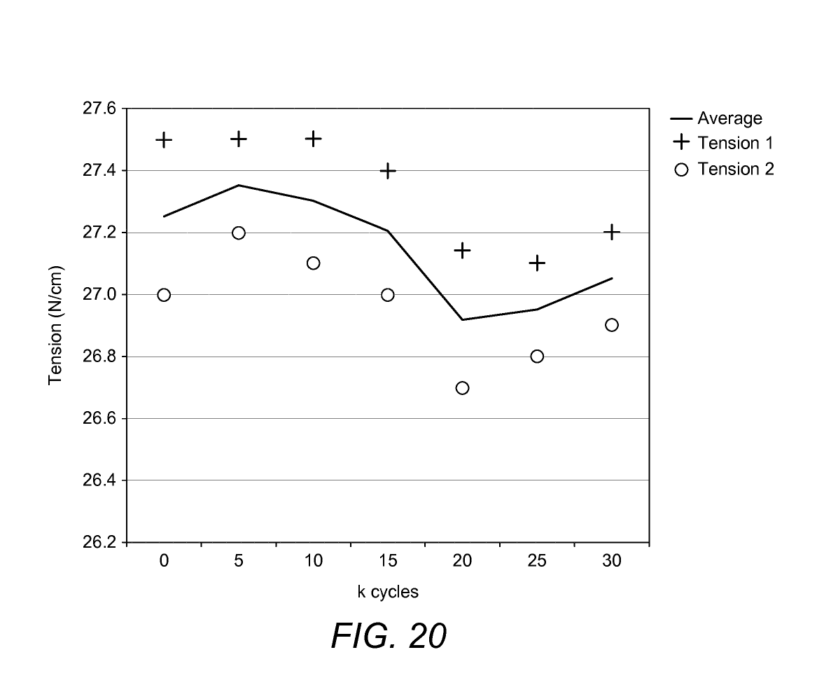

FIG. 20 illustrates measured tensions T1 and T2 as a function of the number of print cycles and as measured in both orthogonal directions to the interface members in accordance with Example #1;

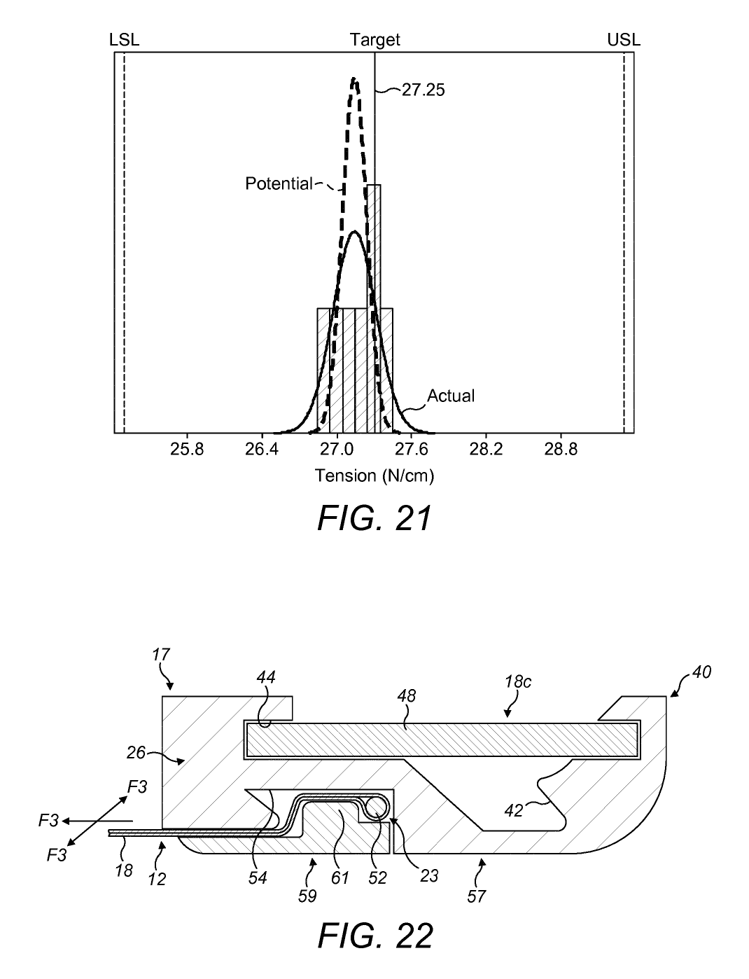

FIG. 21 illustrates a capability histogram for the measured tensions T1 and T2 of Example #1;

FIG. 22 illustrates a vertical sectional view (along section I-I in FIG. 1) through an edge region of a printing screen unit in accordance with a second embodiment of the present invention;

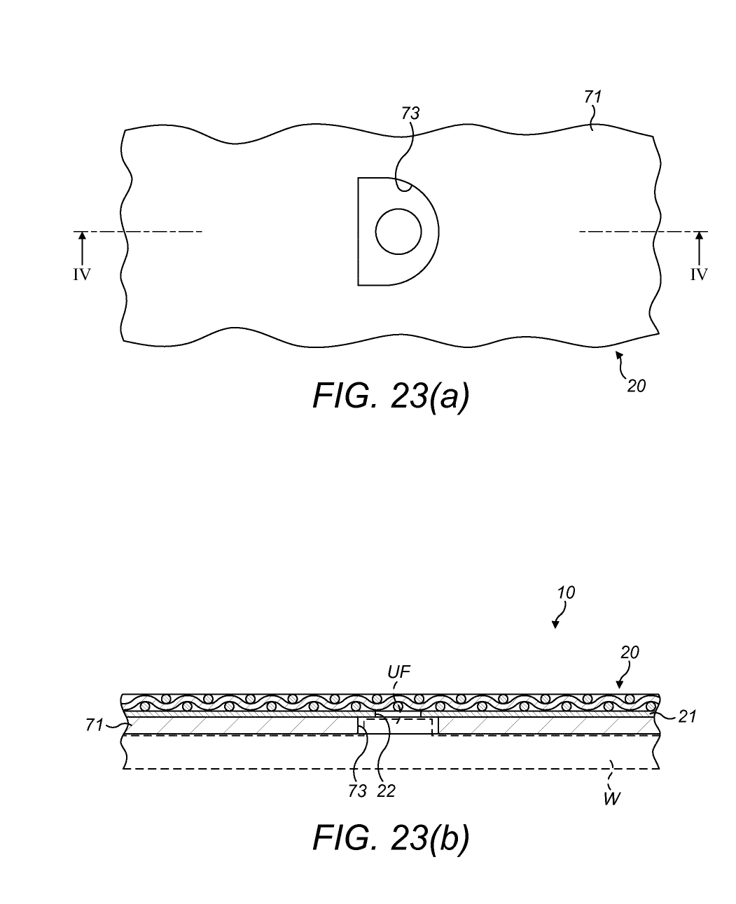

FIG. 23(a) illustrates an underneath plan view of a printing screen as a modification of the printing screen of the printing screen unit of FIG. 1;

FIG. 23(b) illustrates a vertical sectional view (along section IV-IV in FIG. 23(a)) through the printing screen of FIG. 23(a);

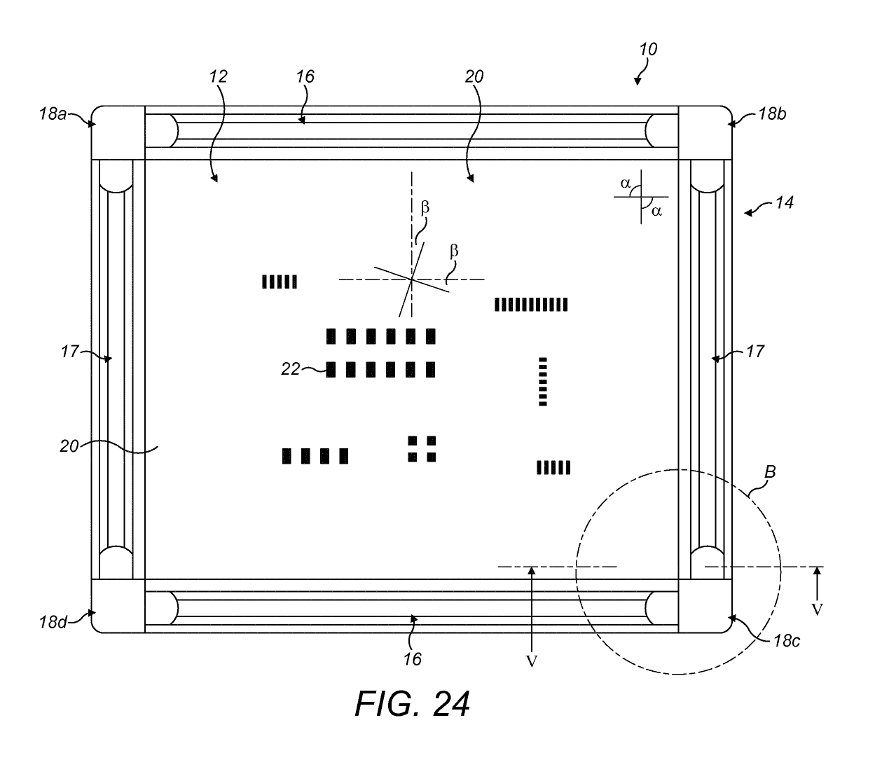

FIG. 24 illustrates a plan view of a printing screen unit in accordance with a fourth embodiment of the present invention;

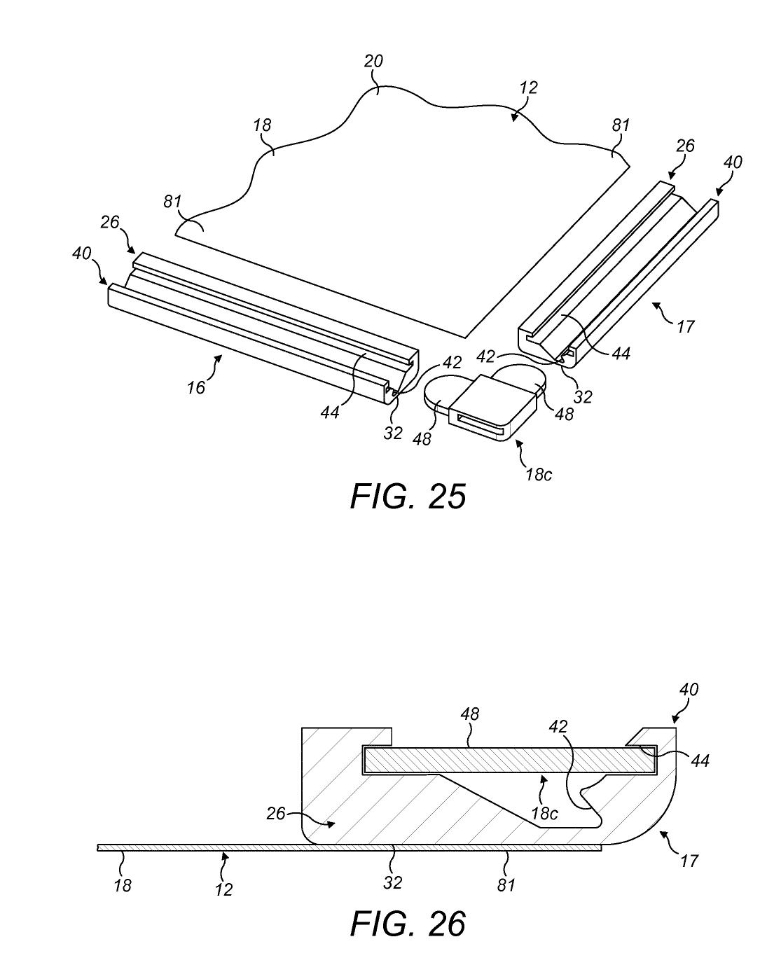

FIG. 25 illustrates an exploded perspective view from above of one corner region (region B in FIG. 24) of the printing screen unit of FIG. 24;

FIG. 26 illustrates a vertical sectional view (along section V-V in FIG. 24) through an edge region of the printing screen unit of FIG. 24; and

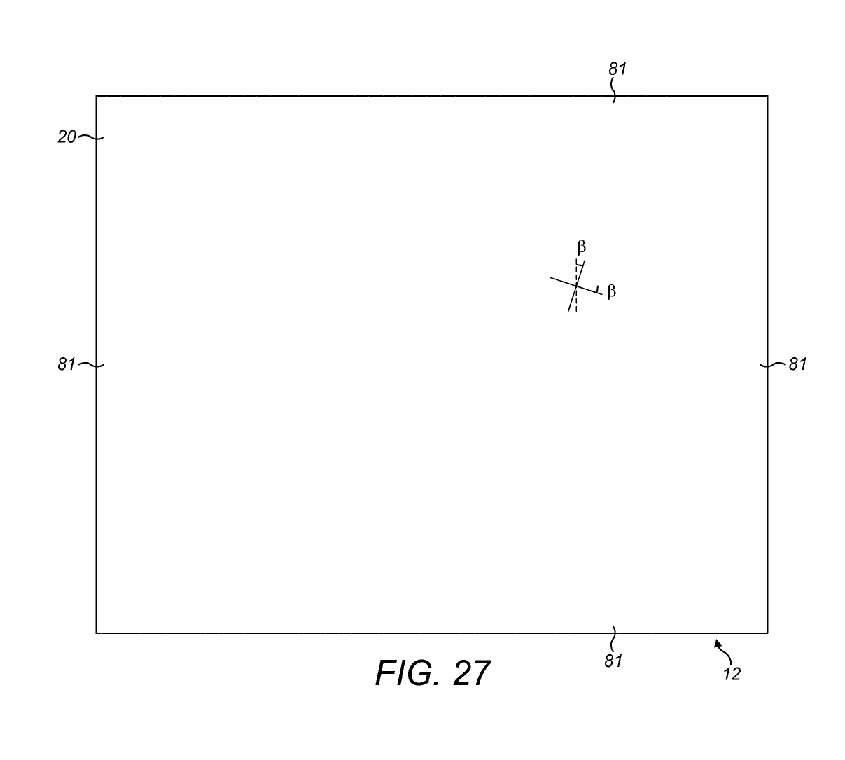

FIGS. 27 to 31 illustrate the operative steps in fabricating the printing screen unit of FIG. 24.

FIGS. 1 to 3 illustrate a printing screen unit 10 in accordance with a first embodiment of the present invention.

The printing screen unit 10 comprises a mesh printing screen 12, in this embodiment of rectangular shape, and a supporting frame 14 which supports the printing screen 12 and comprises first and second pairs of interface members 16, 16, 17, 17 which are attached to the respective pairs of opposite edges of the printing screen 12 and first to fourth corner pieces 18a-d which couple the respective ones of the interface members 16, 16, 17, 17.

In this embodiment the printing screen 12 comprises a first, outer mesh 18 which is attached to the interface members 16, 16, 17, 17 and includes a central aperture 19, and a second, inner mesh 20 which has an emulsion layer 21 on a lower surface thereof and is attached to the periphery of the aperture 19 of the outer mesh 18.

In this embodiment the emulsion layer 21 includes a pattern of printing apertures 22 which define the pattern of deposits to be printed.

In this embodiment the emulsion layer 21 is applied as a coating to the inner mesh 20.

In this embodiment the outer mesh 18 is a metal mesh, here a stainless steel mesh. In an alternative embodiment the outer mesh 18 could be a plastics mesh, such as of polyurethane or polyester.

In this embodiment the pairs of threads, providing the warp and weft, of the outer mesh 18 are aligned so as to have an angle α of substantially 90 degrees to the respective pairs of frame members 16, 16, 17, 17.

In this embodiment the outer mesh 18 has 106 threads per cm, an open aperture size of 56 μm square, a mesh opening percentage of 37%, a thread diameter of 36 μm, a theoretical deposit volume of 30 cm³/m² and an average fabric thickness of 80 μm.

In this embodiment the outer mesh 18 includes attachment elements 23 which are provided by the respective edges thereof, by which the printing screen 12 is attached to the supporting frame 14.

In this embodiment the attachment elements 23 of the outer mesh 18 are bonded, here adhesively bonded, to the interface members 16, 16, 17, 17 of the supporting frame 14.

In this embodiment the inner mesh 20 is a metal mesh, here a stainless steel mesh.

In this embodiment the threads, providing the warp and weft, of the inner mesh 20 are aligned so as to have an acute angle β of between 0 degrees and 45 degrees to the respective pairs of frame members 16, 16, 17, 17.

In a preferred embodiment the threads of the inner mesh 20 are aligned so as to have an angle of between about 10 degrees and about 35 degrees, optionally between about 15 degrees and about 30 degrees, to the respective pairs of frame members 16, 16, 17, 17.

In this embodiment the threads of the inner mesh 20 are aligned so as to have an angle of 22.5 degrees to the respective pairs of frame members 16, 16, 17, 17.

In this embodiment the inner mesh 20 has 157 threads per cm, an open aperture size of 45 μm square, a mesh opening percentage of 51%, a thread diameter of 18 μm, a theoretical deposit volume of 18 cm³/m² and an average fabric thickness of 36 μm.

In this embodiment the outer periphery of the inner mesh 20 overlaps the inner periphery of the outer mesh 18 and the overlapping regions are bonded, here adhesively bonded, such that the inner and outer meshes 20, 18 together provide the printing screen 12.

In this embodiment the pattern of printing apertures 22 is formed by lithography of the applied emulsion layer 21.

The interface members 16, 16, 17, 17 each include an attachment section 26 which defines an attachment surface 32 which extends along the length of the respective interface member 16, 16, 17, 17 and to which a respective one of the attachment elements 23 of the printing screen 12 is attached.

In this embodiment the attachment elements 23 are bonded to the attachment sections 26, here by an adhesive.

In this embodiment the printing screen 12 is bonded to the interface members 16, 16, 17, 17 of the supporting frame 14 when in a tensioned state.

In this embodiment the printing screen 12 is maintained at a pre-tension of 28 N/cm when bonded to the interface members 16, 16, 17, 17 of the supporting frame 14, and released following bonding. Following release of the tension, the tension in the printing screen 12 reduces, largely by relative movement of the interface members 16, 16, 17, 17, such that the printing screen 12 has a residual tension, lower than the pre-tension, when the printing screen unit is not tensioned by an external tensioning mechanism.

In preferred embodiments the printing screen 12 is tensioned to a pre-tension of between about 25 N/cm and about 31 N/cm, optionally between about 26.5 N/cm and about 29.5 N/cm, and optionally between about 27 N/cm and 29 N/cm.

The interface members 16, 16, 17, 17 each further include an engagement section 40 which, relative to the printing screen 12, is disposed outwardly of the attachment section 26 and provides for engagement to a tensioning assembly 101, as will be described in more detail hereinbelow.

The engagement section 40 includes an inwardly-facing engagement surface 42 which extends along the length of the respective interface member 16, 16, 17, 17 and defines a hook arrangement which provides for captive engagement with the tensioning assembly 101.

The interface members 16, 16, 17, 17 each further include a recess 44, in this embodiment of substantially rectangular section, which extends to the distal ends of the interface member 16, 16, 17, 17 to receive the tongue elements 48 of respective corner pieces 18a-d, as will be described in more detail hereinbelow.

The corner members 18a-d each include first and second tongue elements 48, which extend in orthogonal directions, for fitting in respective ones of the recesses 44 in the distal ends of the adjacent interface members 16, 16, 17, 17.

In this embodiment the supporting frame 14 allows for limited movement of the tongue elements 48 in the respective recesses 44 in the direction of a tension as applied in the plane of the printing screen 12, such as to allow for relative movement of respective opposite pairs of the interface members 16, 16, 17, 17 on being tensioned, and thereby tension the printing screen 12 to the required predetermined tension.

FIGS. 4 to 9 illustrate a method of fabricating the above-described printing screen unit 10.

As illustrated in FIG. 4, a piece of the first mesh 18, in this embodiment rectangular in shape, is formed to include the aperture 19 therein, in this embodiment rectangular in shape. In this embodiment the fibers of the warp and the weft in the first mesh 18 extend in parallel relation to respective ones of the sides of the aperture 19.

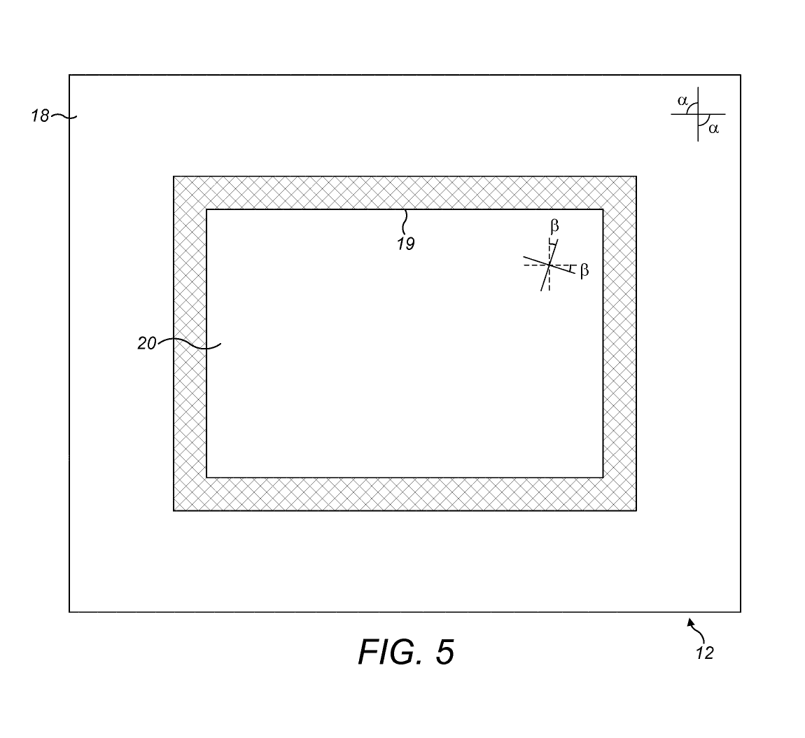

Subsequently, as illustrated in FIG. 5, a piece of the second mesh 20, in this embodiment rectangular in shape, and of greater dimension than the aperture in the first mesh 18 is bonded, in this embodiment adhesively bonded, to the periphery of the first mesh 18 to provide the printing screen 12. In this embodiment the second mesh 20 is arranged such that the fibers of the warp and the weft of the second mesh 20 extend with an angular relation β to the fibers of the warp and the weft of the first mesh 18, in this embodiment an angular relation of 22.5 degrees.

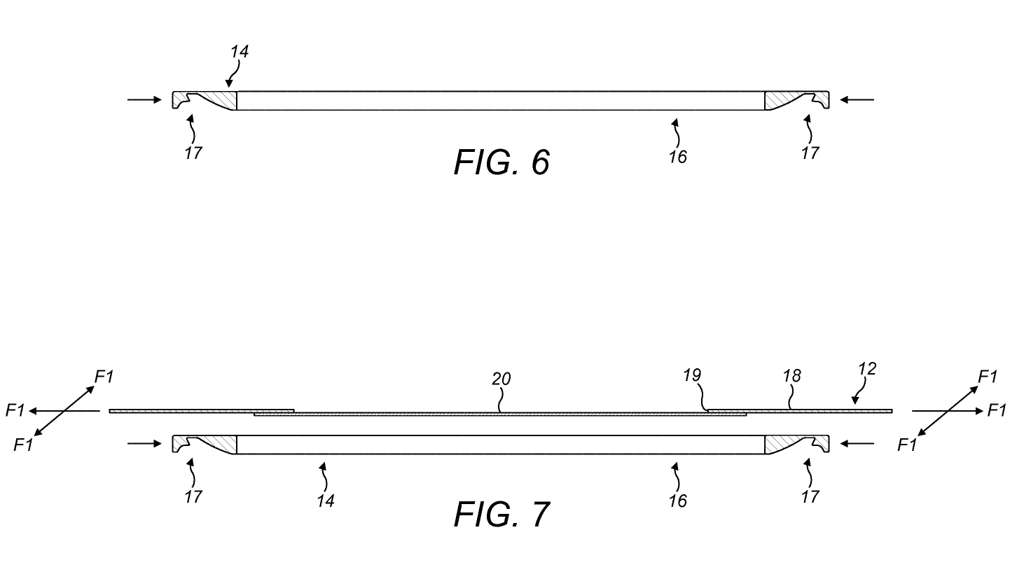

Next, as illustrated in FIG. 6, the supporting frame 14 is set out such that the interface members 16, 16, 17, 17 are arranged in an innermost configuration.

Then, as illustrated in FIG. 7, the printing screen 12 is disposed adjacent the supporting frame 14 and tensioned to a first pre-tension F1 in the two directions parallel to the warp and the weft of the fibers in the first mesh 18, in this embodiment in directions substantially parallel to the edges of the printing screen 12. In this embodiment the initial pre-tension F1 is 26 N/cm.

Then, the printing screen 12 is moved in vertical relation to the supporting frame 14, in this embodiment by raising the supporting frame 14 in relation to the printing screen 12, such that the supporting frame 14 bears against the printing screen 12, whereby the tension in the printing screen 12 is increased to a second pre-tension F2. In this embodiment the supporting frame 14 bears against the printing screen 12 to increase the first pre-tension F1 by 2 N/cm, yielding a second pre-tension F2 of 28 N/cm.

Subsequently, the printing screen 12 is bonded to the supporting frame 14, in this embodiment by applying an adhesive to the attachment elements 23 of the printing screen 12 which engage the attachment surfaces 32 of the interface members 16, 16, 17, 17.

Following completion of the bonding, in this embodiment curing of the adhesive, as illustrated in FIG. 9, the pre-tension F1 is released from the printing screen 12, leaving the printing screen 12 under a residual tension F3, and the printing screen 12 is trimmed to the supporting frame 14.

FIGS. 10 and 11 illustrate a frame assembly 101 in which the printing screen unit 10 is tensioned for use in a screen printing operation.

The frame assembly 101 comprises first, second, third and fourth frame members 106a-d, in this embodiment elongate members, for engaging respective interface members 16, 16, 17, 17 of the supporting fame 14 of the printing screen unit 10, and first, second, third and fourth corner pieces 107a-d connecting the respective ends of the frame members 106a-d.

The frame members 106a-d each comprise a frame element 109, which frame elements 109 are connected to the respective corner pieces 107a-d to define a rigid frame, a plurality of engagement elements 111 for engaging a respective interface member 16, 16, 17, 17 of the supporting fame 14, which engagement elements 111 are pivotally coupled to the frame element 109 such as to be pivotable in one sense to a tensioned position and the other, opposite sense to allow for fitting and removal of the supporting frame 14, and a plurality of biasing elements 117 for applying a biasing force to respective ones of the engagement elements 111, which biasing force acts to bias the engagement elements 111 to pivot in the one sense.

Each of the frame elements 109 includes a central, elongate cavity 119 in which the respective engagement elements 111 are disposed along the length thereof, and a pivot bead 121, in this embodiment a part-circular bead, which extends along the length of the cavity 119 to which the respective engagement elements 111 are pivotally hinged, as will be described in more detail hereinbelow.

Each of the frame elements 109 further includes an elongate, screen recess 123 at a mounting surface for receiving a respective interface member 16, 16, 17, 17 of the supporting frame 14 and into which the respective engagement elements 111 extend to engage the respective interface member 16, 16, 17, 17.

Each of the engagement elements 111 comprises a body 127 which includes a pivot recess 129, in this embodiment a part-circular recess, which extends along the length thereof and in which the pivot bead 121 of the respective frame element 109 is held captive, whereby the engagement elements 111 are captively pivotable to the respective frame elements 109.

Each of the engagement elements 111 further includes a first, engagement arm 131 which extends into the screen recess 123 in the respective frame element 109 for engagement with a respective interface member 16, 16, 17, 17 of the supporting frame 14. In this embodiment the engagement arm 131 extends substantially orthogonally to the mounting surface of the respective frame element 109.

Each of the engagement elements 111 further includes a second, biasing arm 133 which is engaged by respective ones of the biasing elements 117, such as to bias the engagement element 111 to pivot in the tensioning sense, whereby the distal end of the engagement arm 131 is biased in a direction outwardly from the inner edge of the respective frame element 109. In this embodiment the biasing arm 133 extends substantially parallel to the mounting surface of the respective frame element 109 in a direction towards the outer edge of the respective frame element 109.

Each of the engagement elements 111 further includes a third, operating arm 135 which allows for operation of the engagement elements 111 to enable the fitting of the supporting frame 14 and positioning at the tensioned position, as will be described in more detail hereinbelow. In this embodiment the operating arm 135 extends substantially parallel to the mounting surface of the respective frame element 109 in a direction towards the inner edge of the respective frame element 109.

The frame assembly 101 further comprises a counter-biasing element 141 which is operable, in this embodiment commonly, to engage the operating arms 135 of each of the engagement elements 111 to apply a counter-biasing force to the operating arms 135 to counter-bias the engagement elements 111 to overcome the normal biasing force of the biasing elements 117 and cause the engagement elements 111 to adopt a first configuration in which the supporting frame 14 can be fitted to or removed from the fabrication assembly 101 and a second configuration which corresponds to the required configuration of the supporting frame 14 in the tensioned position. In this embodiment the counter-biasing element 141 comprises a single elongate inflatable bladder 143, here a pneumatic bladder, which is threaded through the central cavities 119 of the frame elements 109 adjacent the operating arms 135 of the engagement elements 111 and through the corner pieces 107a-d, and a fluid connector 145, here a quick-fit pneumatic connector, which is connected to one end of the bladder 143 such as to allow for inflation and deflation of the bladder 143 by a separate actuator (not illustrated), with the other end of the bladder 143 being closed.

Operation of the frame assembly 101 will now be described hereinbelow with reference to FIGS. 12 to 15.

As illustrated in FIG. 12, the counter-biasing element 141 is actuated, in this embodiment by inflating the bladder 143, so as to apply a counter-biasing force to the operating arms 135 of the engagement elements 111 to counter-bias the engagement elements 111 to overcome the normal biasing force of the biasing elements 117 and cause the engagement elements 111 to adopt a configuration in which a supporting frame 14 of a printing screen unit 10 can be fitted to the fabrication assembly 101.

As illustrated in FIG. 13, the supporting frame 14 is then located in position on the fabrication assembly 101, in this embodiment with the interface members 16, 16, 17, 17, 17 being located in the screen recesses 123 in the frame elements 109 of the respective frame members 106a-d.

Following the positioning of the supporting frame 14, as illustrated in FIG. 13, the counter-biasing element 141 is de-actuated, in this embodiment by deflating the bladder 143, which de-actuation causes the engagement elements 111 to be pivoted by the biasing force of the biasing elements 117 in the tensioning sense, such as to cause the engagement arms 131 to engage the engagement surfaces 42 of the engagement sections 40 of the interface members 16, 16, 17, 17 and bias the interface members 16, 16, 17, 17 outwardly, such that the printing screen 12 in tensioned to an operative tension F4, in this embodiment being tensioned in orthogonal directions corresponding to the warp and the weft of the fibers of the outer mesh 18.

In this embodiment the operative tension F4 is 27 N/cm. In preferred embodiments the operative tension is from about 25 N/cm to about 31 N/cm, optionally from about 26 N/cm to about 30 N/cm.

Following use of the printing screen unit 10, as illustrated in FIG. 15, the printing screen unit 10 can be de-mounted from the frame assembly 101 by actuating the counter-biasing element 141, in this embodiment by inflating the bladder 143, so as to apply a counter-biasing force to the operating arms 135 of the engagement elements 111 to counter-bias the engagement elements 111 to overcome the normal biasing force of the biasing elements 117 and cause the engagement elements 111 to adopt a configuration in which the printing screen unit 10 can be removed from the frame assembly 101.

With removal of the first tensioning force, the interface members 16, 16, 17, 17 relax marginally, and maintain the printing screen 12 under the residual tension F3, which is lower than the operative tension F4.

The present invention will now be described further hereinbelow with reference to the following non-limiting Example.

### EXAMPLE #1

In a first test, the above-described printing screen unit 10, having test apertures 22 of nominal spacing 153 mm (spacings S1, S2 and S3), nominal length 153 mm (lengths L1 and L2) and nominal line width (widths a, b, c and d), as illustrated in FIGS. 16(a) to (c), was tensioned to 27.25 N/cm in both orthogonal directions to the interface members 16, 16, 17, 17 of the supporting frame 14, and 30000 print cycles were performed using a print squeegee to print a print medium onto a substrate. In this embodiment the squeegee is a polyurethane blade having a shore hardness (D) of 85, operated with a print force of 5 kg at a print speed of 200 mm/s, using Castrol® LM grease as the print medium.

Table 1 and FIG. 17 illustrate measured spacings S1, S2 and S3 between two printed lines 22 as a function of the number of print cycles, and the average and standard deviation for the measured spacings S1, S2 and S3.

TABLE 1

| | Number of Cycles | | | | | | |
|---|---|---|---|---|---|---|---|
| | 0 | 5000 | 10000 | 15000 | 20000 | 25000 | 30000 |
| Spacing S1 (mm) | 153.067 | 153.048 | 153.057 | 153.061 | 153.060 | 153.064 | 153.062 |
| Spacing S2 (mm) | 153.056 | 153.054 | 153.061 | 153.058 | 153.057 | 153.058 | 153.053 |
| Spacing S3 (mm) | 153.041 | 153.037 | 153.041 | 153.034 | 153.030 | 153.028 | 153.024 |
| Average | 153.055 | 153.046 | 153.053 | 153.051 | 153.049 | 153.050 | 153.046 |
| SD | 0.013 | 0.009 | 0.011 | 0.015 | 0.017 | 0.019 | 0.020 |

The P-values for clustering, mixtures, trends and oscillation are 0.358, 0.642, 0.756 and 0.244. These P-values are all greater than 0.05, giving 95% confidence, confirming that the mean pattern spacings are stable throughout the lifetime test. It will be noted that the P-value for trends shows a significant positive trend, which is believed to be an artefact of temperature.

As will be seen, the measured spacings show excellent uniformity, and that this uniformity is maintained at up to at least 30000 cycles

Table 2 and FIG. 18 illustrate measured lengths L1 and L2 of two printed lines 22 as a function of the number of print cycles, and the average and standard deviation for the measured lengths L1 and L2.

TABLE 2

| | Number of Cycles | | | | | | |
|---|---|---|---|---|---|---|---|
| | 0 | 5000 | 10000 | 15000 | 20000 | 25000 | 30000 |
| Length L1 (μm) | 152.925 | 152.928 | 152.937 | 152.948 | 152.948 | 152.958 | 152.961 |
| Length L2 (μm) | 152.911 | 152.913 | 152.920 | 152.921 | 152.922 | 152.929 | 152.929 |
| Average | 152.918 | 152.920 | 152.929 | 152.934 | 152.935 | 152.944 | 152.945 |
| SD | 0.010 | 0.011 | 0.012 | 0.019 | 0.019 | 0.020 | 0.023 |

The P-values for clustering, mixtures, trends and oscillation are 0.020, 0.980, 0.000 and 1.00. It will be noted that the P-value for trends is <0.05, showing a significant positive trend, which is believed to be an artefact of temperature. The low P-value for clustering is a consequence of the upward trend.

As will be seen, the measured lengths again show excellent uniformity, and that this uniformity is maintained at up to at least 30000 cycles.

Table 3 and FIG. 19 illustrate measured widths W1, W2, W3 and W4 on three printed lines 22 as a function of the number of print cycles, and the average and standard deviation for the measured widths W1, W2, W3 and W4.

TABLE 3

| | Number of Cycles | | | | | | |
|---|---|---|---|---|---|---|---|
| | 0 | 5000 | 10000 | 15000 | 20000 | 25000 | 30000 |
| Width W1 | 57.0 | 58.8 | 57.9 | 57.7 | 54.5 | 55.2 | 55.4 |
| (μm) | | | | | | | |
| Width W2 | 57.9 | 57.6 | 57.9 | 56.2 | 54.3 | 54.4 | 55.2 |
| (μm) | | | | | | | |
| Width W3 | 58.9 | 57.8 | 57.8 | 56.3 | 53.4 | 56.6 | 56.4 |
| (μm) | | | | | | | |
| Width W4 | 57.9 | 59.4 | 57.0 | 56.1 | 55.2 | 55.3 | 55.2 |
| (μm) | | | | | | | |
| Average | 57.9 | 58.4 | 57.7 | 56.6 | 54.4 | 55.4 | 55.6 |
| SD | 0.8 | 0.8 | 0.4 | 0.8 | 0.7 | 0.9 | 0.6 |

As will be seen, the measured widths show excellent uniformity, and that this uniformity is maintained at up to at least 30000 cycles.

Table 4 and FIG. 20 illustrate measured tensions T1 and T2 as a function of the number of print cycles for the printing screen unit 10 as measured in both orthogonal directions to the interface members 16, 16, 17, 17, and the average and standard deviation for the measured tensions T1 and T2.

TABLE 4

| | Number of Cycles | | | | | | |
|---|---|---|---|---|---|---|---|
| | 0 | 5000 | 10000 | 15000 | 20000 | 25000 | 30000 |
| Tension | 27.0 | 27.2 | 27.1 | 27.0 | 26.7 | 26.8 | 26.9 |
| T1 (N/m) | | | | | | | |
| Tension | 27.5 | 27.5 | 27.5 | 27.4 | 27.1 | 27.1 | 27.2 |
| T2 (N/m) | | | | | | | |
| Average | 27.3 | 27.4 | 27.3 | 27.2 | 26.9 | 27.0 | 27.1 |
| SD | 0.4 | 0.2 | 0.3 | 0.3 | 0.3 | 0.2 | 0.2 |

FIG. 21 illustrates a capability histogram for the measured tensions, with the actual values for Pp and Ppk of 3.87 and 3.57, and potential values for Pp and Ppk being 6.84 and 6.31.

This tension capability analysis illustrates that the screen tension remains remarkably close to the target tension at least up to 30000 cycles.

In this embodiment, all dimensions were measured with a Nikon® VMR6555, non-contact measuring device, as supplied by Nikon Metrology NV, and tensions were measured with a Koenen Tensionmeter TS 75s, as supplied by Koenen GmbH.

FIG. 22 illustrates a printing screen unit 10 in accordance with a second embodiment of the present invention.

This embodiment is quite similar to the above-described embodiment, but differs in that the attachment sections 23 of the printing screen 12 include engagement elements 52, here elongate elements, which are fixed to the respective edges of the outer mesh 18 of the printing screen 12, and the attachment sections 26 of the interface members 16, 16, 17, 17 each comprise an attachment slot 54 which extends along the length thereof and in which a respective one of the engagement elements 52 of the printing screen 12 is captively located.

In this embodiment the interface members 16, 16, 17, 17 comprise a main interface element 57 which includes the attachment slot 54 and a fixing element 59 which is attached to the main interface element 57 to fix the printing screen 12 to the respective interface member 16, 16, 17, 17.

In this embodiment the fixing element 59 is configured to tension the printing screen 12 to the residual tension F3 when fitted to the main interface element 57.

In this embodiment the fixing element 59 includes a deflector 61 which acts to deflect the outer mesh 18 of the printing screen 12 at a location inwardly of the engagement element 52, which is held in a fixed position, in the operation of fitting the fixing element 59 to the main interface element 57.

In this embodiment the deflector 61 comprises a projection which extends into a recess of the attachment slot 54, but instead the deflector 61 could comprise a recess which is located over a projection in the attachment slot 54.

With this configuration, by providing the engagement elements 52 with a predetermined spatial relationship in relation to the outer mesh 18 of the printing screen 12, the outer mesh 18 of the printing screen 12 is provided with a predetermined, residual tension F3, and, in use, as with the first-described embodiment, the interface members 16, 16, 17, 17 are moved outwardly to tension the printing screen 12 to the required operative tension F4.

FIGS. 23(a) and (b) illustrate a printing screen unit 10 in accordance with a third embodiment of the present invention.

This embodiment is quite similar to the above-described embodiment, but differs in that the inner mesh 20 includes an additional, stand-off layer 71 beneath the emulsion layer 21, which includes a plurality of apertures 73 in registration with the printing apertures 22 in the emulsion layer 21 and acts to provide a stand-off when printing on a workpiece W which includes upstanding features UF.

In this embodiment the apertures 73 in the additional layer 71 are of greater lateral dimension than the apertures 22 in the emulsion layer 21. With this configuration, the emulsion layer 21 directly engages the features UF on the workpiece W, thereby maintaining a sealing gasket between the printing apertures 22 in the emulsion layer 21 and the features UF on the workpiece W.

In this embodiment the additional layer 71 is formed of an emulsion.

In this embodiment the additional layer 71 is formed of an emulsion which is different to that the of emulsion layer 21.

FIGS. 24 to 26 illustrate a printing screen unit 10 in accordance with a fourth embodiment of the present invention.

The printing screen unit 10 of this embodiment is quite similar to the printing screen unit 10 of the first-described embodiment, and thus, in order to avoid unnecessary duplication of description, only the differences will be described in detail, with like parts being designated by like reference signs.

The printing screen unit 10 differs from the first-described embodiment in that the first and second pairs of interface members 16, 16, 17, 17 are fixed immovably to the first to fourth corner pieces 18a-d, in this embodiment with the interface members 16, 16, 17, 17 in the innermost or compressed configuration, whereby the interface members 16, 16, 17, 17 allow for limited resilient deflection on being tensioned by external tensioning mechanisms, such as to provide for tensioning of the supported printing screen 12.

In this embodiment the interface members 16, 16, 17, 17 are bonded to the first to fourth corner pieces 18a-d, here with an adhesive, such as a cyanoacrylate adhesive (Loctite® Black).

The printing screen unit 10 further differs from that of the first-described embodiment, in omitting the outer or carrier mesh 18, and with the inner mesh 20 providing attachment elements 81 which are bonded, here adhesively bonded, directly to the interface members 16, 16, 17, 17 of the supporting frame 14.

In this embodiment the threads, providing the warp and weft, of the single mesh 20 are aligned so as to have an acute angle β of from 0 degrees to about 30 degrees to the respective pairs of frame members 16, 16, 17, 17.

In a preferred embodiment the threads of the mesh 20 are aligned so as to have an angle of less than about 25 degrees to the respective pairs of frame members 16, 16, 17, 17.

In preferred embodiments the threads of the mesh 20 are aligned so as to have an angle of 0 degrees or 22.5 degrees to the respective pairs of frame members 16, 16, 17, 17.

In this embodiment the printing screen 12 has a residual tension of less than 10 N/cm, optionally less than 5 N/cm, when the printing screen unit 10 is not tensioned by external tensioning mechanisms.

FIGS. 27 to 31 illustrate a method of fabricating the above-described printing screen unit 10.

As illustrated in FIG. 27, a piece of mesh 20, in this embodiment rectangular in shape, is arranged such that the fibers of the warp and the weft of the mesh 20 extend with an angular relation (3 to the respective pairs of frame members 16, 16, 17, 17, in preferred embodiments angular relations of 0 and 22.5 degrees.

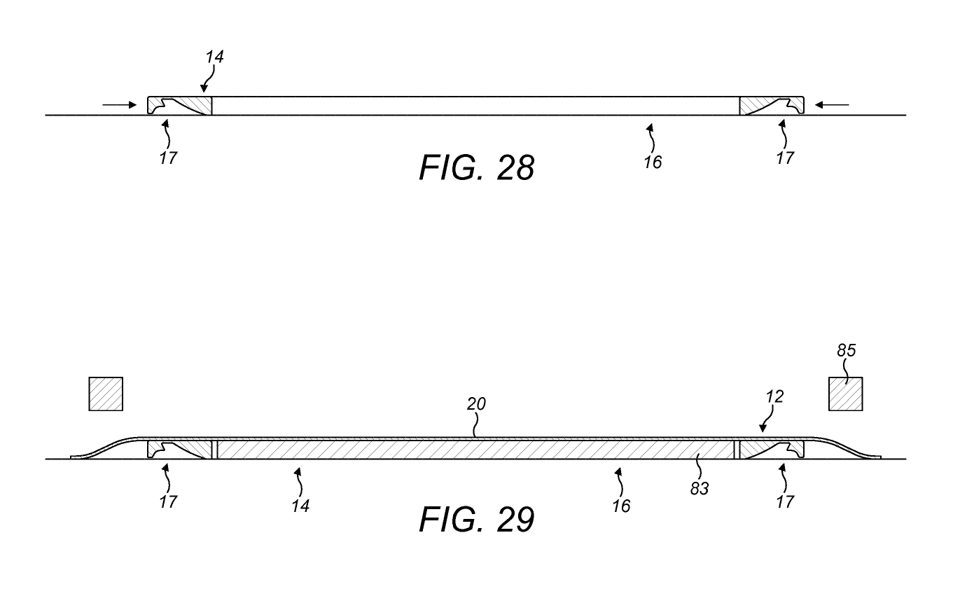

Next, as illustrated in FIG. 28, the supporting frame 14 is set out such that the interface members 16, 16, 17, 17 are arranged in an innermost configuration and immovably fixed to the respective corner pieces 18a-d, in this embodiment adhesively bonded, here by a cyanoacrylate adhesive (Loctite® Black), such that the application of tensioning force to the interface members 16, 16, 17, 17 by external tensioning mechanisms causes resilient deflection of the interface members 16, 16, 17, 17 and tensioning of the supported printing screen 12.

Then, as illustrated in FIG. 29, the printing screen 12 is disposed over the supporting frame 14. In this embodiment a support 83 is located within the space defined by the interface members 16, 16, 17, 17, such as to support the printing screen 12 prior to attachment to the supporting frame 14.

Subsequently, the printing screen 12 is bonded to the supporting frame 14, in this embodiment by applying an adhesive, here a cyanoacrylate adhesive (Loctite® Black), to the attachment elements 81 of the printing screen 12 which engage the attachment surfaces 32 of the interface members 16, 16, 17, 17.

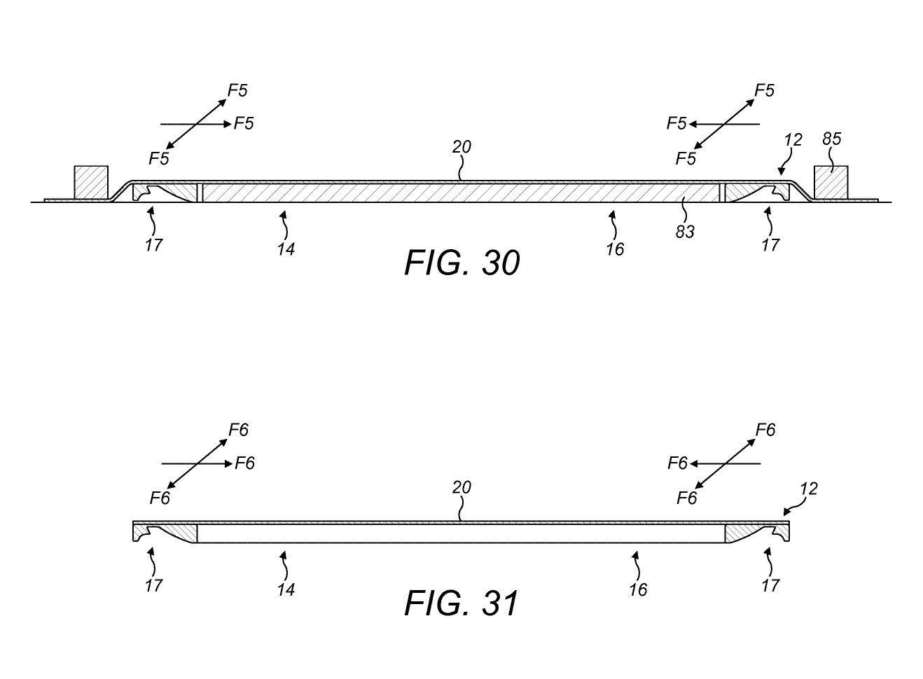

Then, as illustrated in FIG. 30, a tensioning frame 85, in this embodiment rectangular in shape, is disposed over the printing screen 12 adjacent the outer sides of the interface members 16, 16, 17, 17, such as to pull the mesh 20 tight and cause the mesh 20 to be tensioned with a pre-tension F5 in the two directions parallel to the interface members 16, 16, 17, 17 during the bonding process, in this embodiment curing of the adhesive. In this embodiment the pre-tension tension F5 is less than about 10 N/cm.

In this embodiment the tensioning frame 85 is a shim, here formed of Durastone®.

In one embodiment the tensioning frame 85 could be weighted with an additional weight.

Following completion of the bonding, in this embodiment curing of the adhesive, as illustrated in FIG. 31, the pre-tension F1 is released from the printing screen 12, leaving the printing screen 12 under a residual tension F6, and the printing screen 12 is trimmed to the supporting frame 14.

In preferred embodiments the mesh 20 of the printing screen unit 10 can be tensioned to tensions of between about 15 N/cm and about 30 N/cm, in dependence upon the mesh count. By way of example only, the following Examples exemplify the mesh tensions which can be achieved by the described printing screen units 10.

### EXAMPLE #2A

With the mesh 20 being a 500 (SD+CL) mesh, having an angle β of 0 degrees, a tension of 22 N/cm was achieved using the High-Tension VectorGuard Frame (as supplied by DEK, Weymouth, UK).

### EXAMPLE #2B

With the mesh 20 being a 500 (SD+CL) mesh, having an angle β of 22.5 degrees, a tension of 17 N/cm was achieved using the High-Tension VectorGuard Frame (as supplied by DEK, Weymouth, UK).

### EXAMPLE #2C

With the mesh 20 being a 325 (50/30) mesh, having an angle β of 0 degrees, a tension of 28 N/cm was achieved using the High-Tension VectorGuard Frame (as supplied by DEK, Weymouth, UK).

### EXAMPLE #2D

With the mesh 20 being a 200 (90/40) mesh, having an angle β of 22.5 degrees, a tension of 24 N/cm was achieved using the High-Tension VectorGuard Frame (as supplied by DEK, Weymouth, UK).

### EXAMPLE #2E

With the mesh 20 being a 200 (90/40) mesh, having an angle β of 22.5 degrees, and applying an additional weight on the tensioning frame 85, a tension of 29 N/cm was achieved using the High-Tension VectorGuard Frame (as supplied by DEK, Weymouth, UK).

Finally, it will be understood that the present invention has been described in its preferred embodiments and can be modified in many different ways without departing from the scope of the invention as defined by the appended claims.

1-80. (canceled)

81. A printing screen unit comprising a mesh printing screen and a supporting frame which is attached to the printing screen,
wherein the printing screen comprises a first, outer mesh which is attached to sides of the supporting frame and includes an aperture therein, and a second, inner mesh which is attached to the outer mesh,
wherein threads, providing warp and weft, of the inner mesh are aligned so as to have acute angles of between 0 degrees and 45 degrees to the respective sides of the supporting frame, and optionally threads, providing warp and weft, of the outer mesh are aligned so as to have acute angles of between 0 degrees and 10 degrees to the respective sides of the supporting frame, optionally being be substantially orthogonal to the sides of the supporting frame, wherein the printing screen is tensioned by an external tensioning assembly to a first tension when the printing screen is attached to the supporting frame, and the sides of the supporting frame are displaceable such that the sides of the supporting frame are displaced on release of the first tension by the external tensioning assembly, and the printing screen has a second, residual tension lower than the first tension.

82. The printing screen unit of claim 81, wherein the sides of the supporting frame are displaced by deflection or by relative movement.

83. The printing screen unit of claim 81, wherein the supporting frame comprises first and second pairs of interface members which provide the sides of the supporting frame and are attached to the respective pairs of opposite edges of the printing screen, and corner pieces which couple the respective ones of the interface members.

84. The printing screen unit of claim 83, wherein the corner members include tongue elements which are located in recesses in distal ends of the interface members, whereby the supporting frame allows for limited movement of the tongue elements in the respective recesses so as to allow for relative movement of respective opposite pairs of the interface members.

85. The printing screen unit of claim 81, wherein the inner mesh is attached to the periphery of the aperture in the outer mesh.

86. The printing screen unit of claim 81, wherein the inner mesh has an emulsion layer, including a pattern of printing apertures which define a pattern of deposits to be printed by the printing screen unit.

87. The printing screen unit of claim 86, wherein the emulsion layer is applied as a coating to the inner mesh.

88. The printing screen unit of claim 81, wherein the outer mesh is a metal mesh, optionally a stainless steel mesh.

89. The printing screen unit of claim 81, wherein the outer mesh includes attachment elements which are provided by the respective edges thereof, by which the printing screen is attached to the supporting frame.

90. The printing screen unit of claim 89, wherein the attachment elements of the outer mesh are bonded, optionally adhesively bonded, to the supporting frame.

91. The printing screen unit of claim 81, wherein the inner mesh is a metal mesh, optionally a stainless steel mesh.

92. The printing screen unit of claim 81, wherein the threads of the inner mesh are aligned so as to have angles of between 0 and about 35 degrees, optionally between about 10 degrees and about 35 degrees, optionally between about 15 degrees and about 30 degrees, to the respective sides of the supporting frame.

93. The printing screen unit of claim 81, wherein the printing screen is maintained at a tension of between about 25 N/cm and about 31 N/cm, optionally between about 26.5 N/cm and about 29.5 N/cm, and optionally between about 27 N/cm and 29 N/cm, when the printing screen is bonded to the supporting frame.

94. The printing screen unit of claim 81, wherein the first tension is applied in the two orthogonal directions parallel to the warp and the weft of the threads in the outer mesh.

95. A method of fabricating a printing screen unit, comprising:
forming an aperture in a first mesh, wherein threads, providing warp and weft, of the first mesh are aligned so as to be in first and second orthogonal directions;
locating a second mesh over the aperture in the first mesh, wherein threads, providing warp and weft, of the second mesh are aligned so as to have acute angles of between 0 degrees and 45 degrees to the respective ones of the first and second orthogonal directions of the first mesh;
attaching the second mesh to the first mesh so as to provide a mesh printing screen;
tensioning the printing screen by applying a first tension to the printing screen using an external tensioning assembly;
disposing a supporting frame to the printing screen, wherein sides of the supporting frame are displaceable;
attaching the printing screen to the sides of the supporting frame while maintaining the printing screen at the first tension;
following attachment of the printing screen to the supporting frame, removing the first tension applied to the printing screen;
whereby the sides of the supporting frame are displaced by the first tension in the printing screen, whereby the printing screen has a second, residual tension lower than the first tension.

96. A method of screen printing patterns of deposits on workpieces, comprising:
using a printing screen unit comprising a mesh printing screen and a supporting frame which is attached to the printing screen, wherein the printing screen comprises a first, outer mesh which is attached to sides of the supporting frame and includes an aperture therein, and a second, inner mesh which is attached to the outer mesh,
wherein threads, providing warp and weft, of the inner mesh are aligned so as to have acute angles of between 0 degrees and 45 degrees to the respective sides of the supporting frame, and optionally threads, providing warp and weft, of the outer mesh are aligned so as to have acute angles of between 0 degrees and 10 degrees to the respective sides of the supporting frame, optionally being substantially orthogonal to the sides of the supporting frame, wherein the printing screen has a residual tension which is provided by tensioning the printing screen by an external tensioning assembly to a first tension when the printing screen is attached to the supporting frame, and releasing the first tension following attachment of the printing screen to the supporting frame, such that sides of the supporting frame are displaced by the first tension to leave the printing screen with the residual tension which is lower than the first tension;
tensioning the printing screen unit in a frame assembly to a second tension higher than the residual tension; and
printing patterns of deposits on workpieces using the printing screen unit tensioned in the frame assembly.

97. A mesh printing screen, comprising a mesh layer, a first layer of emulsion which is applied to the mesh layer, the first layer including a pattern of printing apertures through which a printing medium is deposited on a workpiece in a printing operation, and a second, stand-off layer which is beneath the emulsion layer and includes a plurality of apertures in registration with the printing apertures in the first layer and acts to provide a stand-off when printing on a workpiece which includes upstanding features.

98. The printing screen of claim 97, wherein the apertures in the second layer are of greater lateral dimension than the printing apertures in the first layer, whereby the first layer directly engages the upstanding features on the workpiece and establishes a sealing gasket between the printing apertures in the first layer and the upstanding features on the workpiece.

99. The printing screen of claim 98, wherein the second layer is formed of an emulsion, optionally an emulsion which is different to that of the first layer.

100. A printing screen unit comprising a mesh printing screen and a supporting frame which is attached to the printing screen, wherein the printing screen comprises a mesh which is attached to sides of the supporting frame,
wherein the supporting frame comprises first and second pairs of interface members which provide the sides of the supporting frame and are attached to the respective pairs of opposite edges of the printing screen, and the interface members are configured so as to be resiliently deflectable on application of tension thereto by external tensioning mechanisms,
wherein threads, providing warp and weft, of the mesh are aligned so as to have acute angles of between 0 degrees and 30 degrees to the respective sides of the supporting frame,
wherein the printing screen is tensioned to a first tension by application of tension to the interface members by external tensioning mechanisms and the printing screen has a second, residual tension lower than the first tension when no tension is applied thereto by the external tensioning mechanisms.

101. The printing screen unit of claim 100, wherein the supporting frame comprises corner pieces which couple the respective ones of the interface members and the interface members are immovably fixed to the corner members, optionally bonded thereto, the corner members optionally including tongue elements which are located in recesses in distal ends of the interface members.

102. The printing screen unit of claim 100, wherein the mesh has an emulsion layer, optionally applied as a coating to the mesh, optionally including a pattern of printing apertures which define a pattern of deposits to be printed by the printing screen unit.

103. The printing screen unit of claim 100, wherein the mesh includes attachment elements which are provided by the respective edges thereof, by which the printing screen is attached to the supporting frame.

104. The printing screen unit of claim 103, wherein the attachment elements of the mesh are bonded, optionally adhesively bonded, to the supporting frame.

105. The printing screen unit of claim 100, wherein the threads of the mesh are aligned so as to have angles of between 0 degrees and about 25 degrees to the respective sides of the supporting frame.

106. The printing screen unit of claim 100, wherein the printing screen is maintained at a tension of less than about 10 N/cm when the printing screen is bonded to the supporting frame.

107. A method of fabricating a printing screen unit, comprising:
providing a printing screen comprising a mesh, wherein threads, providing warp and weft, of the mesh are aligned so as to be in first and second orthogonal directions;
disposing the printing screen over a supporting frame, wherein the supporting frame comprises first and second pairs of interface members which provide sides of the supporting frame and the interface members are configured so as to be resiliently deflectable on application of tension thereto by external tensioning mechanisms, and the threads of the mesh are aligned so as to have acute angles of between 0 degrees and 30 degrees to the respective sides of the supporting frame;
attaching the printing screen to the sides of the supporting frame while maintaining the printing screen at a first tension; and
following attachment of the printing screen to the supporting frame, removing the first tension applied to the printing screen, whereby the printing screen has a second, residual tension lower than the first tension.
